(19) United States
(12) Patent Application Publication
(10) Pub. No.: US 2010/0014855 A1
(43) Pub. Date: Jan. 21, 2010

(54) Fault location system and method for OC-N facility degradation

(76) Inventors: Christopher Arnone, Long Beach, NY (US); David H. Lu, Morganville, NJ (US); James J. Robinson, Lebanon, NJ (US); Andrew Van Kraanen, Holmdel, NJ (US); Mihail Vasilescu, Middletown, NJ (US)

Correspondence Address: AT & T LEGAL DEPARTMENT - Canavan, ATTN: PATENT DOCKETING, ROOM 2A-207, ONE AT & T WAY, BEDMINSTER, NJ, 07921, US

(21) Appl. No.: 12/220,018

(22) Filed: Jul. 21, 2008

(51) Int. Cl. H04B 10/08

(52) U.S. Cl. 398/17

(57) ABSTRACT

A system and method is disclosed that detects the onset of failing optical subnetwork network elements and minimizes the volume of Performance Monitoring (PM) parameter data that must be acquired and trend across a provisioned path by monitoring digital (SONET/SDH) section PM parameter data first, which is used to trigger an examination to determine which optical subnetwork is experiencing degradation. Threshold Crossing Alerts (TCAs) are set for digital section PM parameter data and when a digital section PM parameter is greater than or equal to its TCA, the method identifies which subnetwork is degrading. Once a subnetwork is identified, analog PM parameter data is acquired for network elements employed in the identified subnetwork and determines from monitoring the network elements' analog PM parameter data the network element(s) that is degrading. A maintenance ticket is issued identifying the failing network element(s).

### BACKGROUND OF THE INVENTION

The invention relates generally to identifying subnetwork degradation. More specifically, the invention relates to detecting failing optical subnetwork network elements in an OC-N facility.

Today, a Transport Network Maintenance Center (TNMC) does not know when a large optical facility employing optical transports conveying thousands of Layer 3 (Internet layer) customers begins to degrade. It may be after a month when the degradation becomes an actual component failure at a Synchronous Optical Networking (SONET) level, and the transport protocol switches on ring or equipment protection. Until an actual component failure, upper applications at Internet Protocol (IP), Asynchronous Transfer Mode (ATM) and Frame Relay (FR) may experience faults.

The connectivity between two routers in IP networks or ATM/FR switches is typically performed via an optical carrier line. An optical carrier line is a specification denoted as OC-N, having a speed equal to N(51.8 Mbps). Prior to an actual component failure, the OC-N facility begins to degrade without alarms, but with serious impact to the protocol layers above. For example, an IP network that is being optically transported may exhibit large packet losses. To locate an OC-N facility that is degrading is not difficult, but finding where the degradation is manifesting itself is a complex and difficult task.

What is desired is a system and method that detects the onset of an optical subnetwork component failure which improves Mean Time To Repair (MTTR). By having the failing component location data incorporated in a maintenance ticket, operations personnel can quickly remedy the degradation by replacing the failing component instead of spending hours trouble shooting the optical carrier to find which component is failing.

### SUMMARY OF THE INVENTION

The inventors have discovered that it would be desirable to have a system and method that detects the onset of failing optical subnetwork Network Elements (NEs) and minimizes the volume of Performance Monitoring (PM) parameter data that must be acquired and monitored across a provisioned facility. Embodiments monitor digital (SONET/SDH) section PM parameter data first, which is used to trigger an examination to determine which optical (Dense Wavelength Division Multiplexing (DWDM)) subnetwork is experiencing degradation. Threshold Crossing Alerts (TCAs) are set for the digital section PM parameter data, and when a digital section PM parameter is greater than or equal to its TCA, the method identifies which optical subnetwork is degrading. Once an optical subnetwork is identified, analog PM parameter data is acquired from NEs employed in the identified optical subnetwork and the NE(s) that is degrading is determined from trending the NE(s) analog PM parameter data. A maintenance ticket may be issued identifying the failing NE(s).

The invention provides a “divide and conquer” method for detecting failing optical subnetwork equipment. The method monitors optical subnetwork degradation at a SONET/SDH section level, and when a degradation in a section level is detected, analog PM data is acquired from the optical subnetwork in the section to identify the failing component.

One aspect of the invention provides a method for detecting failing optical subnetwork Network Elements (NEs) in a provisioned facility. Methods according to this aspect of the invention include setting digital Performance Monitoring (PM) parameter Threshold Crossing Alerts (TCAs) for sections in the provisioned facility, acquiring digital PM parameter data corresponding to the TCAs, comparing the acquired digital section PM parameter data with their respective TCAs, if a PM parameter is greater than or equal to its TCA, issuing an alert for that digital PM parameter, identifying an optical subnetwork within the section where the PM parameter responsible for the alert was received, acquiring analog PM parameter data from NEs employed in the identified optical subnetwork, monitoring the analog PM parameter data trend, and identifying degrading optical subnetwork NE(s) from the analog PM parameter trends.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is an exemplary optical facility.

FIG. 2 is an exemplary DWDM multiplexer.

FIG. 3 is an exemplary optical subnetwork component degradation identification system.

FIG. 4 is an exemplary optical subnetwork component degradation identification method.

### DETAILED DESCRIPTION

Embodiments of the invention will be described with reference to the accompanying drawing figures wherein like numbers represent like elements throughout. Before embodiments of the invention are explained in detail, it is to be understood that the invention is not limited in its application to the details of the examples set forth in the following description or illustrated in the figures. The invention is capable of other embodiments and of being practiced or carried out in a variety of applications and in various ways. Also, it is to be understood that the phraseology and terminology used herein is for the purpose of description and should not be regarded as limiting. The use of “including,” “comprising,” or “having,” and variations thereof herein is meant to encompass the items listed thereafter and equivalents thereof as well as additional items.

The terms “connected” and “coupled” are used broadly and encompass both direct and indirect connecting and coupling. Further, “connected” and “coupled” are not restricted to physical or mechanical connections or couplings.

It should be noted that the invention is not limited to any particular software language or any particular optical technology described or that is implied in the figures. One of ordinary skill in the art will understand that a variety of alternative software languages may be used for implementation of the invention.

Embodiments of the invention provide methods, systems, and a computer-usable medium storing computer-readable instructions for detecting degrading optical subnetwork components. The invention is a modular framework and is deployed as software as an application program tangibly embodied on a program storage device. The application code for execution can reside on a plurality of different types of computer readable media known to those skilled in the art.

Synchronous optical networking is a method for communicating digital information using lasers or LEDs over optical fibers for transporting large amounts of telephone and data traffic, and allows interoperability between equipment from different vendors. Two related standards that describe synchronous optical networking are SONET and Synchronous Digital Hierarchy (SDH). SONET/SDH are in wide use.

SONET and SDH allow entire inter-country networks to operate synchronously, greatly reducing the amount of buffering required between elements in a network. Both SONET and SDH can be used to encapsulate earlier digital transmission standards or to support either ATM or Packet over SONET/SDH (POS) networking. SONET and SDH are generic transport containers for moving voice and data.

A SONET system typically includes switches, multiplexers and repeaters, all connected by optical fiber. SONET topologies are usually configured as self-healing, dual-ring networks using dual fiber optic cables.

The SONET physical layer is divided into four sublayers. The lowest sublayer is the photonic sublayer. The three remaining sublayers correspond to the sections, lines and paths. An optical fiber going directly from any device to any other device is referred to as a section. A run between two multiplexers is referred to as a line and the connection between a source node and a destination node with one or more multiplexers and repeaters is referred to as a path. The section sublayer handles a single point-to-point fiber run, generating a standard frame at one end and processing it at the other. Sections can start and end at repeaters, which amplify and regenerate the bits, but do not change or process them. The line sublayer is concerned with multiplexing multiple tributaries onto a single line and demultiplexing them at the other end. To the line sublayer, the repeaters are transparent. When a multiplexer outputs bits on a fiber, it expects them to arrive at the next multiplexer unchanged, no matter how many repeaters are used in between. The protocol in the line sublayer is between two multiplexers and deals with issues such as how many inputs are being multiplexed together and how. The path sublayer and protocol deal with end-to-end issues.

SONET/SDH have a limited number of defined architectures. These architectures allow for efficient bandwidth usage as well as the ability to transmit traffic even when part of the network has failed.

In fiber optic communications, WDM multiplexes multiple optical carrier signals on a single fiber by using different wavelengths of light to carry different signals. This allows for a multiplication in capacity, in addition to enabling bidirectional communications over one strand of fiber. One fiber is transformed into multiple virtual fibers. Multiplexing eight OC-48 signals into one fiber would increase the carrying capacity of that fiber from 2.5 Gbps to 20 Gbps. Because of WDM, single fibers have been able to transmit data at speeds up to 400 Gbps.

A key advantage to WDM is that it is protocol and bit-rate independent. WDM based networks can transmit data in IP, ATM, SONET/SDH, and Ethernet, and handle bit rates between 100 Mbps and 2.5 Gbps (OC-48). Therefore, WDM-based networks can carry different types of traffic at different speeds over an optical channel. Bit-rate transparency is conferred by it operating purely in the optical domain using optical multiplexers (OMUXs), Optical Amplifiers (OAs) and optical demultiplexers (ODMUXs) for long-haul transports over long distances. A WDM transport includes no bit-rate limiting elements that would require a change of optical line components to achieve a higher bit-rate.

WDM systems allow for telecommunications system network capacity expansion without laying additional fiber. By using WDM and OAs, a WDM transport can accommodate several generations of technology development in their optical infrastructure. This is performed using optical-to-electrical-to-optical (OEO) translation at the edge of a DWM subnetwork, permitting interoperation with existing equipment with optical interfaces.

WDM systems are divided by different wavelength patterns such as coarse (CDWM) and dense (DWDM) WDM. DWDM and CWDM differ in the spacing of the wavelengths, the number of channels, and the ability to amplify the multiplexed signals in the optical space. DWDM spaces the individual wavelengths more closely than does CWDM and has a greater overall capacity. CWDM and DWDM system transponders that currently support OC-192 SONET signals can normally support thin-SONET framed 10 Gbps (OC-192) Ethernet. Erbium Doped Fiber Amplifiers (EDFAs) provide efficient wideband amplification for the C-band and Raman amplification provides amplification for the L-band. Presently, optical amplification is not available for CWDM, limiting optical spans to several tens of km.

By using WDM as a transport for Time-Division Multiplexing (TDM), existing SONET/SDH equipment can be preserved. New implementations can eliminate layers of equipment. For example, SONET multiplexing equipment can be avoided altogether by interfacing directly to WDM equipment from ATM and packet switches where OC-48 interfaces are common. Additionally, upgrades do not have to conform to specific bit rate interfaces, as with SONET/SDH, where aggregation of tributaries is locked into specific values.

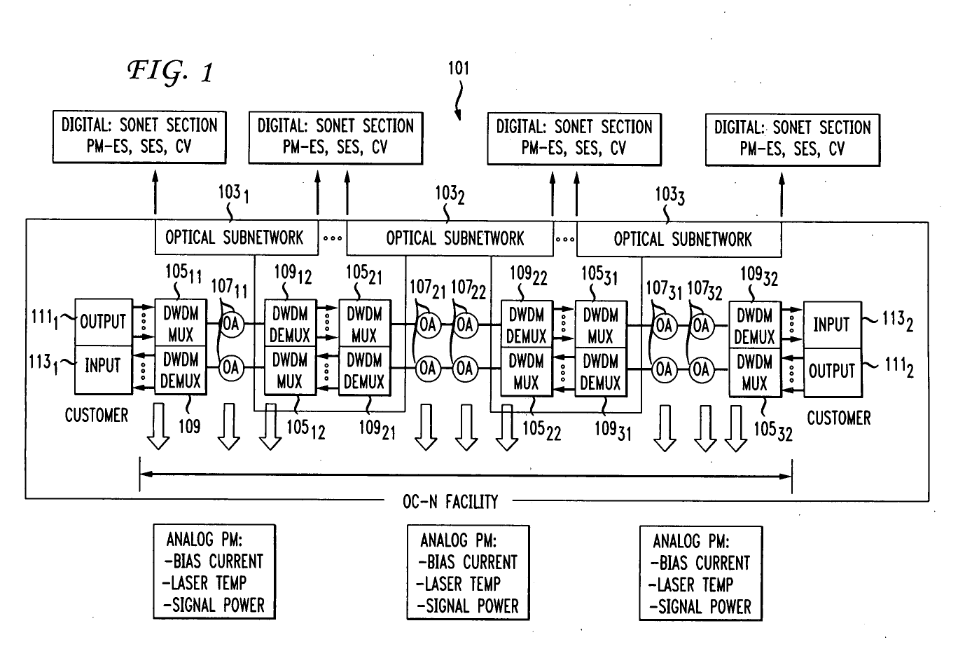

FIG. 1 shows an exemplary provisioned OC-N facility 101 comprising three bidirectional optical (DWDM) subnetworks 103₁, 103₂, 103ₘ (collectively 103). The optical subnetworks 103 may be used in long-haul networks configured as hubbed-rings, multi-hubbed rings, any-to-any rings, meshed rings, and other connection variations, and other types of optical carriers. Each optical subnetwork 103 includes a working fiber and a protection fiber.

The basic elements of an optical subnetwork 103 are a DWDM multiplexer (MUX) 105ₘ₁, one or more OAs 107ₘ₁, 107ₘ₂, . . . 107ₘₒ, depending on fiber length, and a DWDM demultiplexer (DMUX) 109ₘ₁. Each optical subnetwork 103 may be coupled to other optical subnetworks 103 or with customer SONET terminals, ATM switches, router/Layer 3 switches, and others, outputs 111₁, 111₂, . . . 111ₚ (collectively 111) and inputs 113₁, 113₂, . . . 113ₚ (collectively 113) for conveying data.

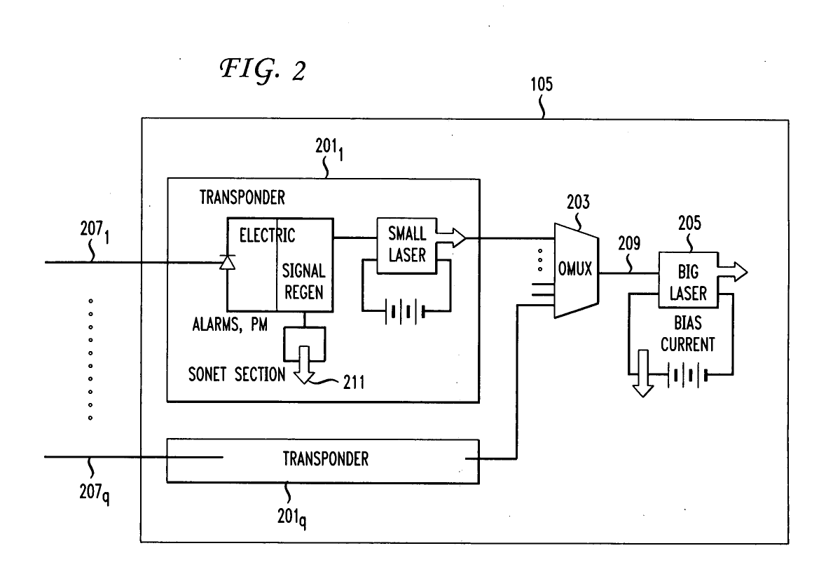

FIG. 2 shows a DWDM MUX 105. Each DWDM MUX 105 includes a transponder 201₁, . . . 201_{q} (collectively 201) for each optical wavelength to be carried, an OMUX 203 and an output laser 205. The wavelength converting transponders 201 may receive input optical signals 207₁, . . . 207_{q} (collectively 207) from a client-layer 111 or from a DWDM DMUX output 109. Each transponder 201 converts the optical signals to the electrical domain, regenerates the electrical signal, converts the electrical signal back to the optical domain and retransmits the signal using a laser 205. It is in the transponder 201 where the digital SONET/SDH section PM parameter data 211 may be acquired. The OMUX 203 combines all received wavelengths of L-band (1530 nm-1565 nm) and C-band (1570 nm-1620 nm) wavelengths into one wavelength-multiplexed light signal 209 and onto a single fiber. Each transponder 201 OEO and laser 205 (analog) derives digital SONET/SDH section 211 and analog PM parameter data, respectively, for OC-N facility 101 data acquisition.

OAs 107 or reconfigurable optical add/drop multiplexers (ROADMs) (not shown) amplify the multi-wavelength signal after traversing distances of approximately 140 km or more. The OAs 107 typically are doped fiber amplifiers that use a doped optical fiber as a gain medium to amplify an optical signal. The signal to be amplified and a pump laser are multiplexed into the doped fiber, and the signal is amplified through interaction with the doping ions. In the EDFAs, the core of a silica fiber is doped with Erbium ions. Optical (analog) PM diagnostics and telemetry are often extracted or inserted at an OA 107 site to allow for localization of any fiber breaks, and signal impairments and degradations.

In order to allow for transmission to remote client-layer systems and for digital domain signal integrity determination, the demultiplexed signals may be sent to OEO output transponders prior to being coupled to their client-layer systems. The functionality of output transponders has been integrated into that of input transponders, where most systems have transponders that support bi-directional interfaces on both their 1550 nm (internal) side and client-facing (external) side.

A DWDM DMUX 109 converts the incoming multi-wavelength signal back into the corresponding individual wavelengths launched at the DWDM MUX 105 and outputs them onto separate fibers for client-layer systems such as a SONET/SDH input 113 to detect.

The DWDM MUX 105 digital interfaces 211 and DWDM DMUX digital interfaces (not shown) are typically managed using Transaction Language 1 (TL1) messages. TL1 is a traditional telecom language for managing and reconfiguring SONET NEs. TL1 or other command languages used by SONET NEs may be carried by other management protocols such as Simple Network Management Protocol (SNMP), Common Object Request Broker Architecture (CORBA) and Extensible Markup Language (XML).

SONET/SDH network management for SONET/SDH NEs have a number of management interfaces. These are an electrical interface and a craft interface. The electrical interface sends SONET TL1 commands from a local management network physically housed in an office where a SONET/SDH NE is located to any location for monitoring. The SONET/SDH TL1 commands are used for local management of that NE and remote management of other NEs. The craft interface are for local technicians who can access a SONET/SDH NE on a port and issue commands through a dumb terminal or terminal emulation program running on a laptop.

SONET/SDH has dedicated Data Communication Channels (DCCs) within the section and line overhead for management traffic. There are three modes used for management, an IP-only stack, using Point-to-Point Protocol (PPP) as a data-link, an Open Systems Interconnection (OSI) only stack, using Link Access Procedures, D-channel (LAP-D) as a data-link, and a dual (IP+OSI) stack using PPP or LAP-D with tunneling functions to communicate between stacks.

SONET/SDH NEs have a large set PM parameter data. The PM parameters allow for monitoring not only the health of individual NEs, but for the isolation and identification of most network defects or outages. Higher-layer network monitoring and management software allows for the proper filtering and troubleshooting of network-wide PM so that defects and outages can be quickly identified and responded to.

The DWDM MUXs 105, OAs 107, intermediate optical terminals (reconfigurable optical add/drop multiplexer) (not shown), and DWDM DMUXs 109 employ an Optical Supervisory Channel (OSC). The OSC is an additional wavelength usually outside the normal optical amplification band. The OSC carries information about the multi-wavelength optical signal as well as remote conditions from each optical NE. It is also normally used for remote software upgrades and user (network operator) network management information. It is the multi-wavelength analog to the SONET/SDH DCC (supervisory channel). The OSC is always terminated at intermediate amplifier sites where it receives local information before retransmission.

A provisioned OC-N facility 101, for example, from Los Angeles, Calif., to New York City, N.Y., may include a plurality of optical subnetworks 103. The volume of PM parameter data collected across all NEs employed in the facility from Los Angeles to New York City would be voluminous and impracticable to monitor. The PM parameter data can be collected as SONET/SDH section PM parameter data (digital PM data) 211 and optical subnetwork 103 PM parameter data (analog PM data). The SONET/SDH section digital PM parameter data is collected at the transponder level 211. Embodiments minimize the amount of digital and analog PM parameter data acquired across a provisioned OC-N facility by monitoring only the digital PM parameter data first, to determine if an optical subnetwork 103 within a section is degrading. Predetermined digital PM parameter data Threshold Crossing Alerts (TCAs) are compared with corresponding acquired digital PM parameter data. When a digital PM parameter is greater than or equal to its respective threshold, a TCA for that parameter is issued, identifying the optical subnetwork 103 within the section where the PM parameter responsible for the alert was received. Once an optical subnetwork is identified, analog PM parameter data is acquired from the identified optical subnetwork and is trend. The trend analog PM parameter data is input to a Rule Based Expert System (RBES) which determines the optical subnetwork 103 NE(s) that is degrading. A request for issuing a maintenance ticket may be made identifying the failing NE(s) for replacement.

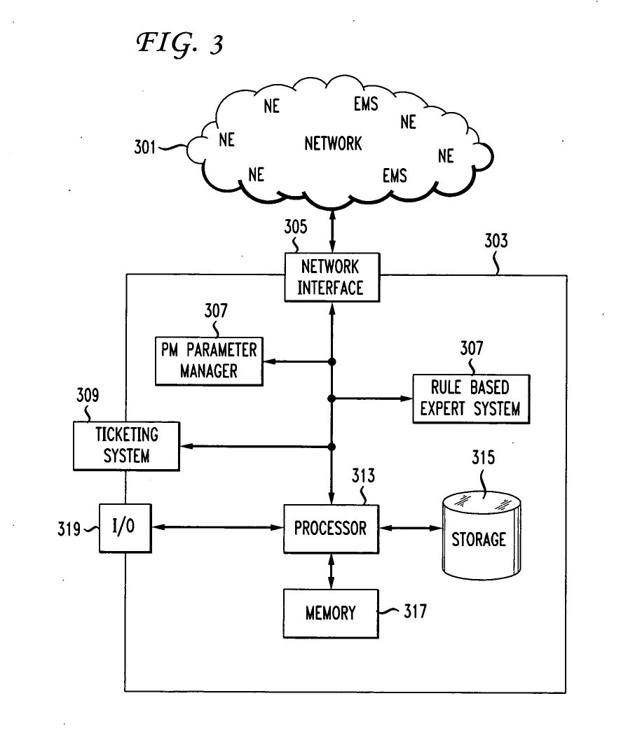

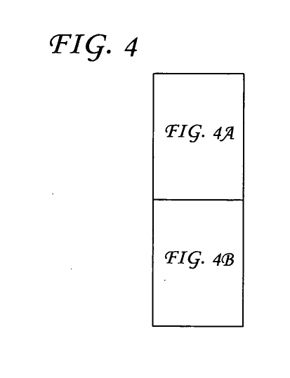

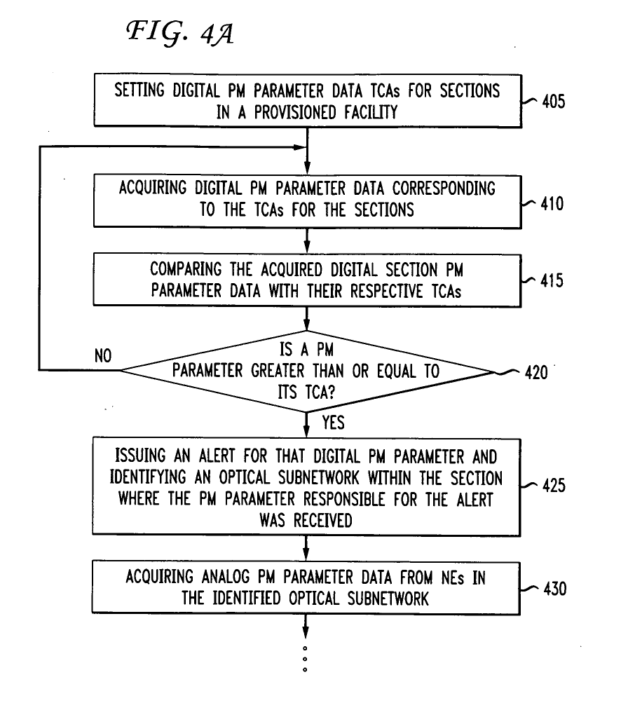

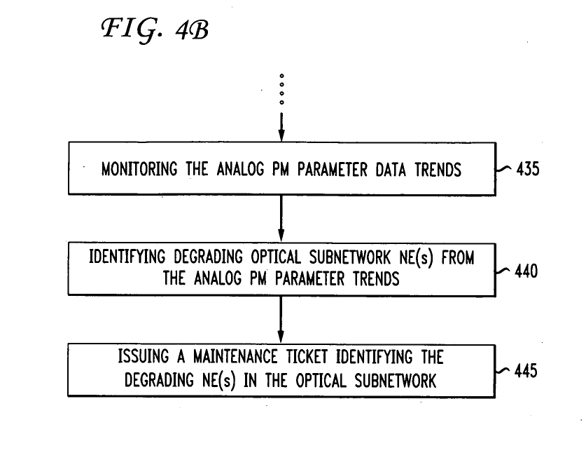

FIG. 3 shows an embodiment of a system framework 303 and FIG. 4 shows the method. The framework 303 includes a network interface 305 coupled to a network and configured to acquire network topology information and historical PM parameter data, such as for provisioned facilities from Element Management Systems (EMSs), and issue TL1 commands to acquire PM parameter data from provisioned facilities via the TL1 commands and OSC channels for the optical subnetworks 103. An EMS manages one or more NEs and the features of each NE individually. NEs expose one or more management interface that the EMS uses to communicate with and to manage them. The management interfaces use a variety of protocols including SNMP, TL1, CL1, XML, and CORBA. The network interface 305 is coupled to a PM parameter manager/inventory database 307, a ticketing system 309, an RBES 311 and a processor 313. The processor 313 is coupled to storage 315, memory 317 and I/O 319.

For each provisioned facility, the inventory database 307 assembles a database from the acquired data and stores the facility data as a connection traverses from a source node to a destination node. For example, a path connection may be provisioned from Los Angeles, Calif. to New York City, N.Y., establishing Los Angeles as the source node (A) and New York City as the destination node (Z). During path provisioning, a plurality of intervening SONET/SDH sections and optical subnetworks 103 may be employed between the two path terminating nodes. The inventory database 307 maintains all path connection information and the identity of each NE in the path.

Polled in predetermined time periods using TL1 commands and OSC channels for a predefined path issued by the PM parameter manager 307, or acquired via the EMS(s), digital PM parameter data is acquired for analysis.

The framework 303 may be implemented as a computer including a processor 313, memory 317, storage devices 315, software and other components. The processor 313 is coupled to the network interface 305, I/O 319, storage 315 and memory 317 and controls the overall operation of the computer by executing instructions defining the fault location configuration. The instructions may be stored in the storage device 315, for example, a magnetic disk, and loaded into the memory 317 when executing the configuration. The invention may be implemented as an application defined by the computer program instructions stored in the memory 317 and/or storage 315 and controlled by the processor 313 executing the computer program instructions. The computer also includes at least one network interface 305 coupled to and communicating with a network such as partially shown in FIG. 1 to interrogate and receive PM parameter data. The I/O 319 allows for user interaction with the computer via peripheral devices such as a display, a keyboard, a pointing device, and others. The ticketing system 309 is configured to issue maintenance tickets depending on the conclusions yielded by the RBES 311 regarding the health of a customer's provisioned path.

Predetermined synthetic TCAs are set in the RBES 311 to monitor digital SONET/SDH section PM parameter data (step 405). The digital PM parameter data 211 is acquired from optical transponders 201, 211 at the digital electrical level in response to TL1 commands issued by the network interface 305 or from EMSs.

One digital PM parameter that is monitored is a digital SONET/SDH section Code Violation (sCV). At an optical transponder 201, there is a pre-defined sCV time period, for example, 15 minutes, to incrementally collect transmission errors, if any. For each transmission error, a counter counts for fifteen minutes, and outputs the number of errors. At the end of the pre-defined time period, an sCV value is posted.

TCAs set error levels for each sCV digital PM parameter value. During a predetermined digital PM parameter accumulation period (step 410), if the current value of a digital PM parameter is greater than or equal to its corresponding TCA, a TCA is issued for that digital PM parameter (steps 415, 420). The TCAs provide early detection of performance degradation.

Alerts occur when a TCA is met or exceeded and are forwarded to the RBES 311 as triggers to check analog PM parameter data. Each TCA contains a timestamp when the alert occurred, the Common Language Facility code (CLFI) and the port identifier (ID) of the NE (MUX 105) that originated the digital PM parameter, the digital PM parameter, and the NE PM parameter value. Each PM parameter TCA can be setup at the NE level (provisioned) and are referred to as hardware TCAs. TCAs setup in the framework 303 are referred to as synthetic.

For synthetic thresholds (although hardware thresholds may be used), the historic digital PM parameter data 307 may be collected from path provisioned NEs directly, or from EMSs by the PM parameter manager 307. If digital PM parameter data is collected with values greater than or equal to their TCAs, a synthetic TCA message(s) is forwarded to the RBES 311.

For synthetic TCAs, the PM manager 307 collects the historic PM parameter looking for buckets in which the threshold was reached. As described above, PM parameter data may be acquired every 24 hours by the PM parameter manager 307 or the EMSs. PM parameter data is typically acquired, or counted, in 15 minute buckets, totaling 96 buckets per 24 hour period.

Embodiments initially monitor the digital SONET PM parameters. Based on synthetic, or hardware TCAs being met or exceeded, an optical subnetwork 103 is identified as degrading and the framework 303 begins acquiring the optical subnetwork analog PM parameter data for that optical subnetwork (steps 425, 430). As described above, the digital SONET/SDH parameter data is acquired from transponders 211 at DWDM MUXs 105 at a receiving end. If any TCAs are issued for parameter data acquired, the exceeded error count “points” upstream, identifying the section and the optical subnetwork in that section.

Analog PM parameter data across the identified optical subnetwork 103, from the Target Identifier/Access Identifier (TID/AID) for each DWDM MUX 105, OA 205, OA 107, and DWDM DMUX 109 is trend by the PM parameter manager 307 via the OSC by the network interface 305 or by an EMS. For example, analog power readings such as laser bias current, laser temperature, signal power, and others are acquired and trend by the PM parameter manager 307.

The acquired analog PM parameters for each DWDM subnetwork 103 NE in the identified subnetwork are monitored to determine which NE(s) is/are degrading (step 435). The RBES 311 trends each DWDM subnetwork 103 NE in the identified subnetwork, and applies rules that reveal a predicted NE failure (step 440).

The method trends the analog PM parameter data for the NEs within the identified DWDM subnetwork to examine if the subnetwork NEs are degrading over time. Most degradation observed will not show as a sudden subnetwork perturbation, but as a gradual increase (worsening) if degrading. For example, a laser's bias current will increase to maintain its desired output power over time indicating that the laser is degrading. Data tables are maintained for each trend subnetwork NE analog PM parameter. A maintenance ticket may then be issued by the RBES 311 and ticketing system 309 for NE replacement identified by its (TID/AID) and CLFI (step 445). Remedying an NE predicted to fail, or exhibiting degraded performance, may be performed by replacement during a Planned Maintenance period, for example, at or after midnight when the subnetwork is experiencing less traffic.

One or more embodiments of the present invention have been described. Nevertheless, it will be understood that various modifications may be made without departing from the spirit and scope of the invention. Accordingly, other embodiments are within the scope of the following claims.

What is claimed is:

1. A method for detecting failing optical subnetwork Network Elements (NEs) in a provisioned facility comprising:
setting digital Performance Monitoring (PM) parameter Threshold Crossing Alerts (TCAs) for sections in the provisioned facility;
acquiring digital PM parameter data corresponding to the TCAs;
comparing the acquired digital section PM parameter data with their respective TCAs;
if a PM parameter is greater than or equal to its TCA, issuing an alert for that digital PM parameter;
identifying an optical subnetwork within the section where the PM parameter responsible for the alert was received;
acquiring analog PM parameter data from NEs employed in the identified optical subnetwork;
monitoring the analog PM parameter data trend; and
identifying degrading optical subnetwork NE(s) from the analog PM parameter trends.

2. The method according to claim 1 further comprising issuing a maintenance ticket identifying the degrading optical subnetwork NE.

3. The method according to claim 1 wherein analog PM parameter data includes laser bias current, laser temperature and laser signal power.

4. The method according to claim 1 wherein acquiring digital PM parameter data further comprises issuing TL1 commands to NEs in the provisioned facility.

5. The method according to claim 1 wherein optical subnetwork NEs include multiplexers, optical amplifiers and demultiplexers.

6. The method according to claim 1 wherein a TCA set at the NE level is a hardware TCA.

7. The method according to claim 1 wherein a TCA is set at the software level is a synthetic TCA.

8. The method according to claim 1 wherein acquiring digital PM parameter data is from NEs within the provisioned facility.

9. The method according to claim 1 wherein acquiring digital PM parameter data is from an Element Management System (EMS) for the provisioned facility.

10. A system for detecting failing optical subnetwork Network Elements (NEs) in a provisioned facility comprising:
means for setting digital Performance Monitoring (PM) parameter Threshold Crossing Alerts (TCAs) for sections in the provisioned facility;
means for acquiring digital PM parameter data corresponding to the TCAs;
means for comparing the acquired digital section PM parameter data with their respective TCAs;
if a PM parameter is greater than or equal to its TCA, means for issuing an alert for that digital PM parameter;
means for identifying an optical subnetwork within the section where the PM parameter responsible for the alert was received;
means for acquiring analog PM parameter data from NEs employed in the identified optical subnetwork;
means for monitoring the analog PM parameter data trend; and
means for identifying degrading optical subnetwork NE(s) from the analog PM parameter trends.

11. The system according to claim 10 further comprising means for issuing a maintenance ticket identifying the degrading optical subnetwork NE.

12. The system according to claim 10 wherein analog PM parameter data includes laser bias current, laser temperature and laser signal power.

13. The system according to claim 10 wherein means for acquiring digital PM parameter data further comprises means for issuing TL1 commands to NEs in the provisioned facility.

14. The system according to claim 10 wherein optical subnetwork NEs include multiplexers, optical amplifiers and demultiplexers.

15. The system according to claim 10 wherein a TCA set at the NE level is a hardware TCA.

16. The system according to claim 10 wherein a TCA is set at the software level is a synthetic TCA.

17. The system according to claim 10 wherein means for acquiring digital PM parameter data is from NEs within the provisioned facility.

18. The system according to claim 10 wherein means for acquiring digital PM parameter data is from an Element Management System (EMS) for the provisioned facility.
